(19) United States
(12) Patent Application Publication
(10) Pub. No.: US 2025/0212860 A1
(43) Pub. Date: Jul. 3, 2025

(54) REMOTELY MANUALLY OPERATED MECHANICAL FISHING REEL

(71) Applicant: Cristopher Scott Southers, Port Aransas, TX (US)

(72) Inventor: Cristopher Scott Southers, Port Aransas, TX (US)

(21) Appl. No.: 19/085,351

(22) Filed: Mar. 20, 2025

Related U.S. Application Data
(63) Continuation-in-part of application No. 18/487,221, filed on Oct. 16, 2023.
(60) Provisional application No. 63/416,245, filed on Oct. 14, 2022.

(51) Int. Cl. A01K 89/015; A01K 97/22

(52) U.S. Cl. CPC A01K 89/0186; A01K 97/22

(57) ABSTRACT

An adapter designed with and around chains, belts and gears connects to a conventional fishing reel to retrieve fishing line using foot pedal rotation. The pedals may be attached to a fighting chair that couples rotational energy from rotating pedals in only one direction to cause the fishing reel to retrieve line.

### CROSS-REFERENCES TO RELATED APPLICATIONS

This is a continuation-in-part of application Ser. No. 18/487,221 filed Oct. 16, 2023, which claims the benefit of 63/416,245 filed Oct. 14, 2022. Each of these prior applications are incorporated herein by reference for all purposes as if expressly set forth.

### STATEMENT REGARDING FEDERALLY

### SPONSORED RESEARCH OR DEVELOPMENT

### BACKGROUND

Before explaining example non-limiting embodiments, it is helpful to explain the structure and operation of a conventional deep sea fishing reel 10 as known in the art.

FIG. 1 shows an example of a conventional deep sea fishing reel 10 such as with adjustable drag as described for example in U.S. Pat. Nos. 5,497,953, 2,714,271 and 1,353,113 (each incorporated herein by reference). Such a conventional reel 10 may include a winding lever 305 having a rotating handle 306 at a distal end. An integral gear connected to the winding lever moves a central shaft by means of an internal overdrive gear. The central shaft rotates the spool 310 on which the fishing line is wound. Rotating the handle 306 and associated lever 305 clockwise will cause the internal spool 310 to rotate counterclockwise due to the rotation reversing function of the internal overdrive gear within the reel, causing the spool to retrieve the line. See for example White, “Top Saltwater Offshore Heavy-Tackle Reels,” Marlin Magazine (Jun. 22, 2017), www.marlinmag.com/top-heavy-tackle-reels/

In more detail, the FIG. 1 conventional prior art offshore fishing reel 10 comprises a housing 300 having one or more harness mounting lugs 300a, 300b to mount to a harness of a fighting chair. A spool tension adjustment 302 adjusts tension on a spool 310 to prevent birdnesting of the fishing line. A spool drag adjustment 308 adjusts drag on the spool (i.e., the amount of friction or braking applied to the spool when the spool is rotated in a line-deployment direction of rotation to deploy line as the line is pulled from the spool). In one embodiment, a gear speed selector 304 adjusts or switches the ratio of rotational angle of the handle 306 and associated handle arm 305 to rotational angle of the spool 310 when the handle arm is rotated to rotate the spool in a line-retrieval direction (i.e., different gear ratios are applied to give the angler more control over turns of the handle to linear distance of line recovered).

A conventional spinning reel's gear ratio is the number of times the reel's rotor and line roller rotate with one full 360-degree turn of the reel handle. Reels typically have an internal “overdrive” gearing system that multiplies the handle rotation so for example one full rotation of the handle causes the spool to rotate 3, 4, 5, 6, 7 or even 8 revolutions. Lower gear ratios in the 4:1 to 5:1 range are generally best suited to bait fishing since they equate to slower retrieve speeds and more cranking power (torque). Anything above 5:1 is generally considered to be high speed when referring to inshore saltwater spinning reels because it allows high speed retrieval of the line.

One of the advantages of using a reel with a higher gear ratio is that you'll be able to pick up line faster because there are more revolutions of the rotor with each turn of the handle. Higher gear ratios are often considered to be more versatile and can be of benefit in a few specific situations. For example, if you hook up with a bonefish and it takes a screaming run across the flats toward the boat, it's important to pick up any slack line quickly and keep tension on the line. A higher gear ratio can also help when fishing for snook around dock pilings or mangrove shorelines because you'll be better equipped to get the fish away from structure quickly. However, very strong fish may require a lower gear ratio and thus more torque. See e.g., “How to Select the Best Gear Ratio for Inshore Saltwater Spinning Reels” (Mercury Marine Jun. 13, 2022), mercurymarine.com/en/us/dockline/how-to-select-the-best-gear-ratio-for-inshore-saltwater-spinning-reels/?j=355116&sfmc_sub=36624452&1=111_HTML&u=9390801&mid=7232290&jb=1082.

Typical deep sea/offshore fishing reels of the type shown in FIG. 1 may have a two gear ratios such as the following with a control to switch between them:
3.5:1 or 1.3:1
3.1:1 or 1.5:1
4:1:1 or 1.4:1.

As noted above, a gear ratio less than 4:1 allows for more power (torque) to fight bigger fish. This is best for heavier fish that might be tough to reel in. A gear ratio greater than 6:1 retrieves baits fast. This is best for lighter and faster fish, or ones that yo-yo in their speeds, requiring fast intake and output with your line. See e.g., Emma Mure, “HOW TO CHOOSE A SALTWATER FISHING REEL” publiclands.com/blog/a/how-to-choose-a-saltwater-fishing-reel

Meanwhile, the speed at which the spool 310 rotates is not the sole factor that determines rate of linear line retrieval; the effective diameter of the spool also plays a part in line retrieval rate. For this reason, the spool 310 of such a reel typically holds a long length of backing that is wound onto the spool to provide a suitable effective spool diameter to deploy and retrieve the actual fishing line being used. A conventional fishing line such a monofilament fishing line, a braided fishing line and/or a fluorocarbon fishing line is attached to the backing. The fishing line is typically threaded through the eyelets of a conventional rod made of fiberglass, graphite or some other resilient composite.

Attached to the distal end of the fishing line is tackle such as one or more hooks, one or more weights, one or more floats, one or more swivels, one or more artificial lures and one or more baits. Skilled anglers rig such a fishing line in a number of different ways depending on conditions, preferences and experience to make the fishing line attractive to target fish the angler wishes to catch. Example rigs include but are not limited to knocker rig, fish finder rig, carolina rig, dropper loop rig, paternoster rig and double drop bottom rig. A stiff hook rig is a type of rigging used for trolling lures when targeting large game fish such as blue marlin, allowing the hook to remain in a more upright position when trolled through the water to make it easier for the hook to penetrate the fish's mouth when it strikes the lure.

Such offshore reels when operated from the deck of a boat are often used in conjunction with a “fighting chair.” A fighting chair is typically fastened to the deck of a fishing boat for use by an angler to catch large fish. A good description of the structure, use and operation of a prior art fighting chair can be found in U.S. Pat. No. 5,647,161, now in the public domain and incorporated herein by reference in its entirety for all purposes.

Generally, an angler sits in and is often strapped into the fighting chair. The angler typically holds a rod and reel combination that is mounted to a rod holder often located between the legs of the angler and retained by straps. The rod holder is gimbal-mounted to the fighting chair so the angler can change the angle of the rod relative to horizontal to apply leverage to a fishing line threaded through eyelets of the rod. The fighting chair is rotatable about at least a vertical axis on its pedestal so an assistant can rotate the fighting chair toward the direction of a fish that is running astern of the boat (the chair thus is said to “follow the fish”). Some fighting chairs are also gimbaled to be rotatable forward and back to provide adjustable pitch (i.e., deviation from horizontal) so the angler can shift their weight forward and backwards to change the horizontal angle of the chair and thus the rod.

To fish from a fighting chair, an assistant can throw a hooked (and baited or lured) fishing line attached to a spool of a fishing reel attached to the rod, into the water behind the stern of the boat to troll for fish, or the line can be deployed by a drone or by other means. Once a fish is hooked, it runs against the drag provided by the fishing reel and tires. When the fishing line goes slack, the angler begins rotating the reel's handle to retrieve the fishing line onto the spool and continue to “fight” with the fish to eventually bring the fish up to the boat where it can be gaffed or netted.

The '161 patent recognizes that most fighting chairs rely primarily on the muscles of the upper body including the arms and back to pull the fish toward the boat. However, some combat veterans have lost one or both arms due to injuries. Conditions other than amputation can also prevent or impede a person from using their upper body to reel in a fish when the person is seated in a fighting chair. It is a highly worthwhile goal to enable such physically challenged people to fish.

There are many examples of power-assisted (“electric”) fishing reels that use an electric motor to retrieve the fishing line. See e.g., U.S. Pat. No. 7,886,478. However, a big part of the fun of fighting and landing a fish is manually controlling the rate at which the fishing line is retrieved in order to slowly tire the fish as it is running behind the boat. Activating an electric motor power-assist fishing line retrieval feature on a reel is not the same as manually retrieving the fishing line. Moreover, tournaments that operate under the International Game Fish Association require power accessories to be physically removed from the reel before the act of hooking or fighting a fish. Under those guidelines, any fish that strikes a bait or lure being fished with a reel with power accessories still attached—whether or not under electric operation—will not be eligible for record consideration. See e.g., igfa.org/2021/02/24/igfa-adopts-new-language-for-electric-reels/

See Additional References: see U.S. Pat. Nos. 3,196,571 and 5,647,161.

Accordingly, while much work has been done in the past to assist disabled or physically challenged people to fish, further improvements are needed. Improved equipment is needed that will allow a physically challenged person to obtain their passion back for fishing and/or create a new passion that they had possibly accepted could never be possible in their future. With our veterans' suicide rate at an all-time high, we need to show that there are still people willing to sacrifice everything for them just like they did for us.

### BRIEF DESCRIPTION OF THE DRAWINGS

FIG. 1 shows a prior art offshore fishing reel.

FIG. 2 shows one example fishing apparatus embodiment.

FIGS. 3 and 4 show another example fishing apparatus embodiment.

FIG. 4A shows the FIGS. 3 and 4 fishing apparatus embodiment with a cover removed to expose the gearbox.

FIG. 5 shows a further example embodiment of a fishing apparatus.

FIGS. 6 & 7 shows different views of a hand operated flex shaft drive mechanism.

FIG. 8 is an exploded view of the FIGS. 6 & 7 hand operated flex shaft drive mechanism.

FIG. 8A is an exploded view of a gear box.

FIG. 9 is a detailed view of an input shaft.

FIG. 10 is an exploded view of the input shaft.

FIG. 11 shows a perspective view of a reel including a spool.

FIG. 12 shows an exploded view of the FIG. 11 reel.

### DETAILED DESCRIPTION OF EXAMPLE NON-LIMITING EMBODIMENTS

Anglers all over the world use such offshore fishing reels as described above every day to catch fish. Unfortunately, a veteran or other person who is missing one or both hands or arms cannot manipulate or use such a fishing reel. In particular, for someone without hands, it seems impossible to hold the rod and manipulate the handle of the reel to retrieve the line. Example embodiments herein allow such a disabled person to retain the rod and operate the reel using their feet instead of their hands.

### Example Reel Modification

In one example as described below, such a conventional off-the-shelf reel is modified or its design is modified to permit the reel to be operated by an external mechanical mechanism under the manual control of the angler.

Such an external mechanism can be manually operated for example by the person's feet instead of or in addition to their hands in some embodiments, or may be manually operated by the person's hand or hands in other embodiments.

Example embodiments provide a one-way coupling/decoupling feature that selectively decouples the external mechanism from the reel. In particular, no rotational energy will be coupled from the reel to the external mechanism while a fish is running against the drag of the reel to rotate the spool to feed line out from the reel. However, when the angler manually operates the external mechanism in a direction to reel line onto the spool, the mechanical rotational energy generated by external mechanism will be mechanically coupled (e.g., with a flexible coupling shaft in one embodiment) to the reel carrying the line, in order to cause the reel to reel in the line. Such a one-way unidirectional coupling protects the angler from all force exerted onto the line by a running fish, while enabling the angler to use their own muscle power to reel the fish in once the fish has tired and the line goes slack.

The external mechanism can take several forms.

As noted above, in one example, the external mechanism can comprise a manually-foot-operated machine. The manually-foot-operated machine can in one embodiment comprise one or two rotatable foot pedals operated by a person's foot or feet.

In another example, the external mechanism can comprise a manually hand operated machine. The manually hand operated machine can in one embodiment comprise one or two rotatable hand levers operated by the person's hand or hands.

In another example, the external mechanism can comprise a manually hand operated machine combined with a manually foot operated machine.

In yet another example embodiment, the external mechanism can comprise an electric motor to provide an automatic assist to reeling in a fish. However, the embodiments herein are generally devoid of any electrical or electronic components, are purely mechanical in structure, and have no electric motor(s) or other electrical drive component(s) or mechanism(s) or assists in order to comply with fishing tournament regulations.

In example embodiments, the external mechanism can be easily connected to and disconnected from the reel via a conventional flexible coupling shaft.

In one example, the angler rotates foot pedals clockwise which in turn acts through another gear to turn the spool of the reel counterclockwise. Turning the spool on the fishing reel counterclockwise causes the spool to retrieve the fishing line. The angler is thus able to use their legs in place of hand-operating the fishing reel handle and lever arm to manually reel in a fish.

In this embodiment, force of a fish pulling on the fishing line will not rotate the pedals. The pull on the fishing line applied by the fish instead applies force against the drag provided by the conventional reel. A selective coupling or one-way clutching mechanism is used to protect the angler from force a fish exerts on the fishing line, and allows instead the drag control of the reel to control the rate at which a fish can take fishing line off the spool of the reel without interference by either resistance or rotation of the pedals.

### Example Scenario 1: Remote Hand Operated Mechanism

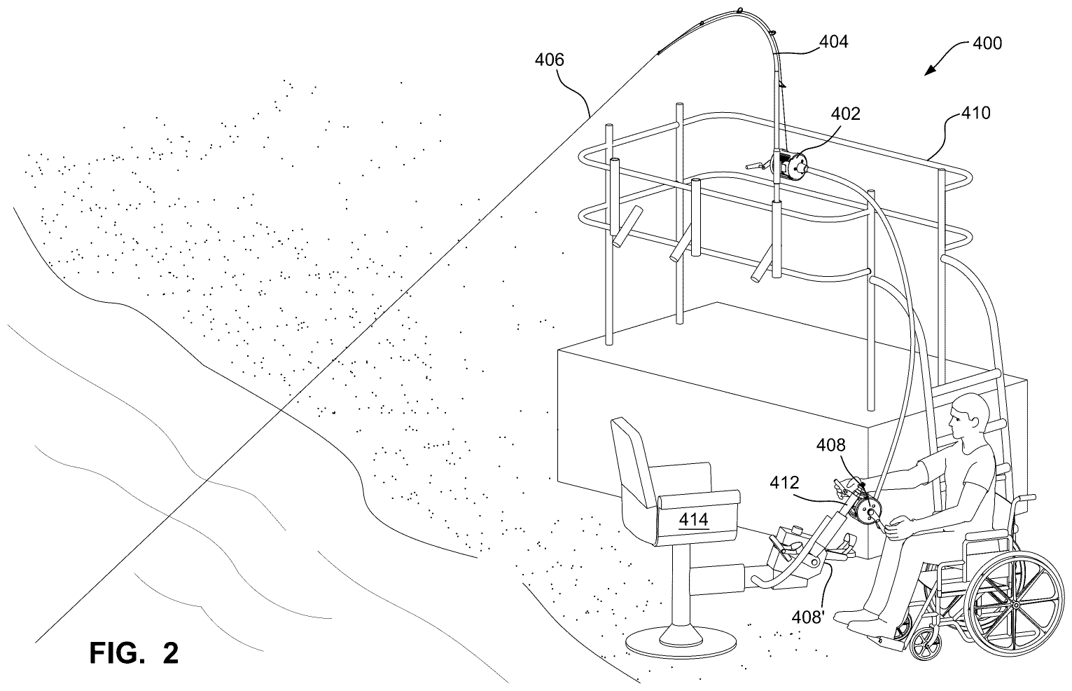

FIG. 2 shows an example fishing apparatus including a fishing reel 402 attached to a rod 404. The reel 402 contains a spool that has fishing line 406 on it. As with a conventional fishing reel, reel 402 exerts drag on the fishing line 406 that resists a fish pulling on the line 406. The amount of drag may be adjustable or fixed depending on the configuration of the reel 402.

In the example shown, the reel 402 is mechanically coupled to an external manual drive mechanism 408 via a flexible shaft 410. The reel 402 includes an internal one-way clutch that does not couple to the flexible shaft 410, torque spinning the reel spool in a payout direction. This one-way clutch will however transmit torque in the opposite direction to the spool in order to cause torque from the flex shaft to rotate the spool to reel in the line 406. Such transmitted reel-in torque can be mechanically generated by the external manual drive mechanism 408.

In the example shown, external manual drive mechanism 408 comprises a manual (hand-operated and/or foot-operated) drive mechanism. The external manual drive mechanism 408 is shown mounted to a post 412 but could be mounted in other ways, held between the legs, or even just handheld. The hand-operated drive mechanism 408 provides a manually generated torque when the user rotates his hands. The user (shown here in a wheelchair) can rotate the hand-operated drive mechanism 408 with his hands to generate torque that remotely (i.e., through the flex shaft) manually drives reel 402 to reel in a fish, without fear that the fish pulling line 406 out will cause the hand-operated mechanism 408 to rapidly reel out in the opposite direction and hurt the user's hands.

FIG. 2 further shows an alternative, foot operated drive mechanism 408′ that can be substituted for hand operated drive mechanism 408. The foot operated drive mechanism 408′ can be substituted for hand operated drive mechanism 408 simply by pulling flexible shaft 410 out of the hand operated drive mechanism (thereby disconnecting it) and inserting the flex shaft 410 into the foot operated drive mechanism. In this case, the foot operated drive mechanism is mounted onto a “fighting chair” but other mounting arrangements are possible.

### Example “Fighting Chair”

FIGS. 2 & 3 show an example manually operated fishing system 100 comprises a “fighting chair” 414 having a seat 104 mounted onto a vertical pedestal 106. The seat is designed to support the posterior of an angler. Pedestal 106 has at its bottom end a mounting plate 108 configured to be mounted to a conventional pedestal mounting plate on the deck of a boat or ship. The mounting plate may be a Class A type that includes e.g., 6 mounting screws around a hole that accepts a central post. The pedestal and mounting plate is designed to support someone in the seat 104 on a boat deck when the boat is underway at any speed. For example, pedestal 106 can comprise a Class AP pedestal designed to be used while the boat is underway. This seat hardware for passenger boat seats meets the following American Boat & Yacht Council (ABYC) specifications:
Swivel locking mechanism sustains torque of at least 30 ft. lbs.
A seat designed for occupancy while the vessel is underway at any speed
Employs a locking mechanism for each plane or axis of movement
Seat with a fore/aft adjustment sustains static loads of at least 300 lbs. for 3 minutes, in mid position
Seat with a vertical adjustment feature has a positive locking mechanism
Sustains at least 10 impacts of at least 225 lbs.

In one embodiment, the pedestal 106 can rotate 360 degrees in its deck mounting. Such a pedestal 106 can be fastened to the desk of a ship or boat, or could be mounted to some other object such as a tow mounting bracket of a vehicle for dock or shoreline use, as shown in FIG. 7.

FIGS. 2 & 3 further shows a frame connected to and supported by pedestal 106. In this example, the frame supports the feet of a person seated in seat 104, and in particular provides rotary pedals that the person's feet can rest on and manipulate.

In one example, a roughly horizontal frame member 110 extends from the pedestal 106. Frame member 110 in turn supports a projecting frame member 114 that extends at an angle away from the seat 104. A cross frame member 112 maintains the projecting frame member 114 in position. Adjustments may be provided to adjust the projecting angle/distance of the projecting frame member 112 relative to the seat.

Projecting frame member 114 has a rod receiving structure 116 configured to receive and retain a conventional fishing rod 118. Fishing rod 118 is conventional and includes a butt end 120 that can be inserted into the rod receiving structure 116. The rod receiving structure 116 may comprise for example a hollow tubular member into which the rod butt end 120 may be inserted. The rod receiving structure 116 retains the rod so it does not pull out in an unexpected way, but so that rods can be removed and replaced as needed (i.e., the rods are interchangeable and different rods can be swapped in and out as desired).

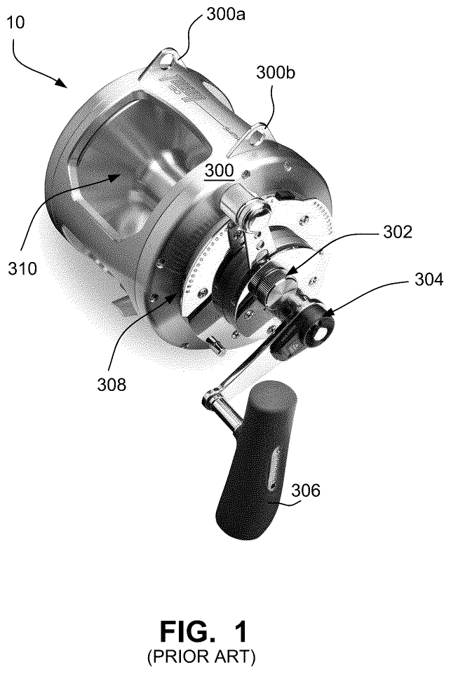

Conventionally, the rod 118 would normally be attached to the reel such as shown in FIG. 1, and the harness loops 300a, 300b on the reel would be attached to clips connected to the chair to prevent the rod from being pulled out of the rod receiving structure 116. Alternatively, the reel may be attached to the chair frame using any mechanical structure such as one that connects to the foot of the reel in the same way the reel can be attached to and retained by the rod.

In the example shown, the fighting chair structure is mounted to the pedestal on gimbals so the entire fighting chair is able to rotate (e.g., about multiple axes in multiple degrees of freedom) about the pedestal pivot point. The seat 414 may have a back and arm-rests, and can be adjustable for the length of the angler's legs. When an angler sits on the seat 414, they can adjust the seat to place their feet onto rotary pedal mechanism 408′.

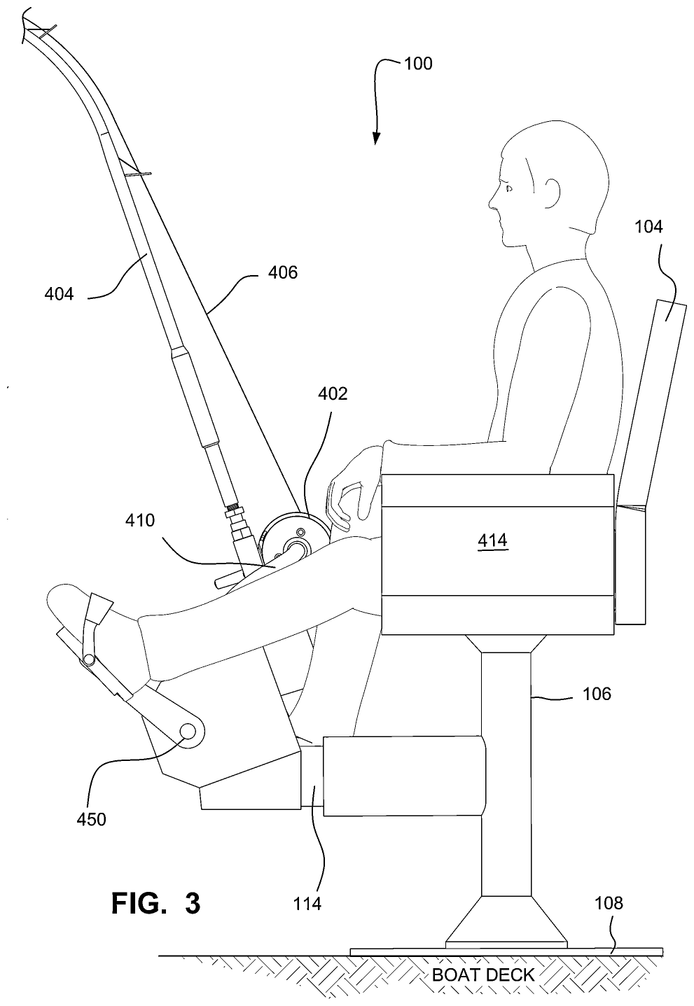

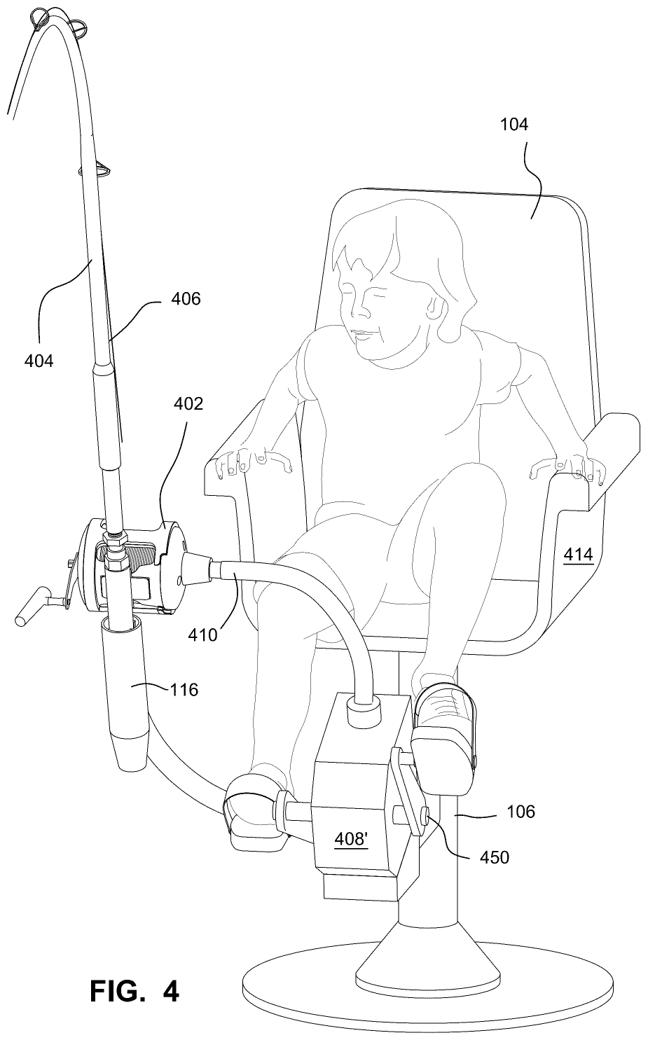

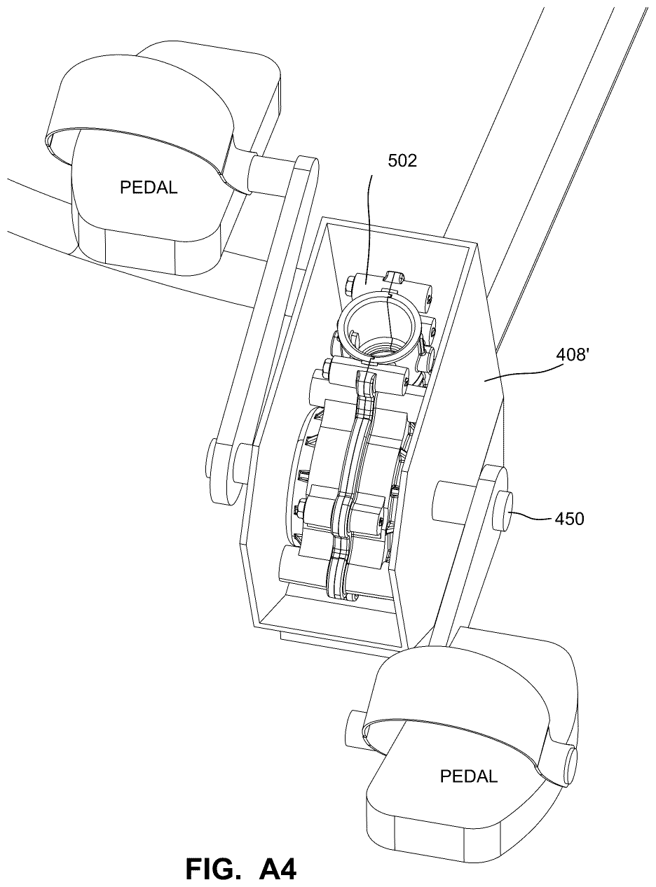

A pedal mechanism 450 in one embodiment includes a conventional bicycle hub and sprocket assembly with foot pedals mounted on each side. See also FIG. 4A. The angler may place their left and right feet onto the respective pedals and pedal as they would pedal a bicycle. Positioning the feet in this way provides stability to keep the angler in the fighting chair as the fighting chair rotates and/or pivots. Rotating the foot pedals also generates a rotational torque that is mechanically coupled to the fishing reel 402 via the flexible shaft 410 in order to retrieve the fishing line onto the spool of the reel. Comparing FIG. 2 with FIGS. 3 and 4/4A, flexible shaft 410 can be configured to have any desired length to provide drive torque from the foot-operated drive or drive mechanism 408′ to the reel 402.

In one embodiment, this drive torque is mechanically coupled to a conventional fishing reel 402 such as shown in FIG. 1, to enable the angler to retrieve fishing line onto the spool of the fishing reel by pedaling the rotary pedals in a predetermined (e.g., clockwise) direction. The faster the user pedals, the faster the rotation of the flex shaft, and the faster the spool of the reel 402 will retrieve the fishing line. In one embodiment, a conventional fishing reel retrieves fishing line by rotating a handled shaft on the righthand side of reel in a clockwise direction. In such embodiment, an extension to said shaft on the lefthand side of the reel is rotated in a counterclockwise direction (which is the same as rotating the right-hand handled shaft in a clockwise direction) by foot-operated rotary pedal power.

In one embodiment, the mechanical coupling between the pedal driven shaft and the fishing reel spool is unidirectional—that is, pedaling in one direction such as clockwise or “forward” rotation as if riding a bicycle causes the reel to retrieve fishing line onto the spool of the reel to pull a hooked fish closer to the boat or otherwise retrieve the line; whereas pedaling in an opposite direction such as counterclockwise or “reverse” rotation does not rotate or affect the spool (i.e., no torque will be transmitted). In another embodiment, pedaling in one direction such as clockwise or “forward” as if riding a bicycle is decoupled from the reel and thus does not rotate or affect the reel operation, whereas pedaling in an opposite direction such as counterclockwise or “backward” causes the reel to retrieve fishing line onto the reel spool to pull a hooked fish closer to the boat. In some embodiments both directions of pedal rotation are mechanically coupled to the spool, whereas in other embodiments only one direction of pedal rotation is mechanically coupled to the spool. A preferred arrangement in some contexts is to provide only one direction of torque transmission so that reverse rotation of the pedals by the user does essentially nothing, and so that reverse rotation of the spool within the reel will not cause any torque to the transmitted to the foot pedals. The foot pedals in this embodiment turn in only one direction, i.e., clockwise in a direction that will result in spooling line onto the spool, i.e., line retrieval.

As is well known, conventional reels have adjustable drag mechanisms that can be set to automatically provide a desired amount of resistance to fishing line being fed out of or deployed from the reel such as when the fish is running after being hooked by a hook tied to the end of the fishing line. During such times, an angler does not need to turn the rotary handle of a conventional reel or otherwise control the reel in any way to deploy more fishing line—rather, the game fish pulls fishing line from the reel against the force of the spool's drag. No torque is transmitted to the flex shaft in this scenario because of a one-way clutching within the gear box. One way to describe the operation including the one-way clutching: the mechanism shown transmits the strength of the fish but not its pull.

When the fish tires and the fishing line goes slack, the angler begins pedaling with their feet in an appropriate direction (e.g., clockwise) to turn the spool of the reel in an appropriate direction to retrieve the fishing line onto the spool. The faster the angler pedals, the faster the reel spools in (retrieves) the fishing line. The more force the angler's foot or feet exerts onto the pedals, the more force the reel exerts against a fish trying to pull fishing line out of the reel. The manual force the angler's feet apply is thus pitted against the force of the running fish trying to swim away from the boat, with the angler trying to exert enough torque to tire the fish but not so much as to break the fishing line.

In one embodiment in a fighting chair configuration, an assistant can rotate the chair so it faces the direction of the fish—following the fish. In this way, the angler can reel in a fish hooked on the fishing line by using their calf and thigh muscles to pull the fish closer to the boat with no hands or hand manipulation at all (the only angler-operated control of spool rotation comes from foot pedal operation, and the spool rotates only in response to (a) a fish pulling line from the reel or (b) the angler rotating the pedals to retrieve line onto the reel). When the fish tires and has been pulled close to the boat, an assistant can use a device such as a gaffer (hook) or a net to bring the exhausted fish onto the boat.

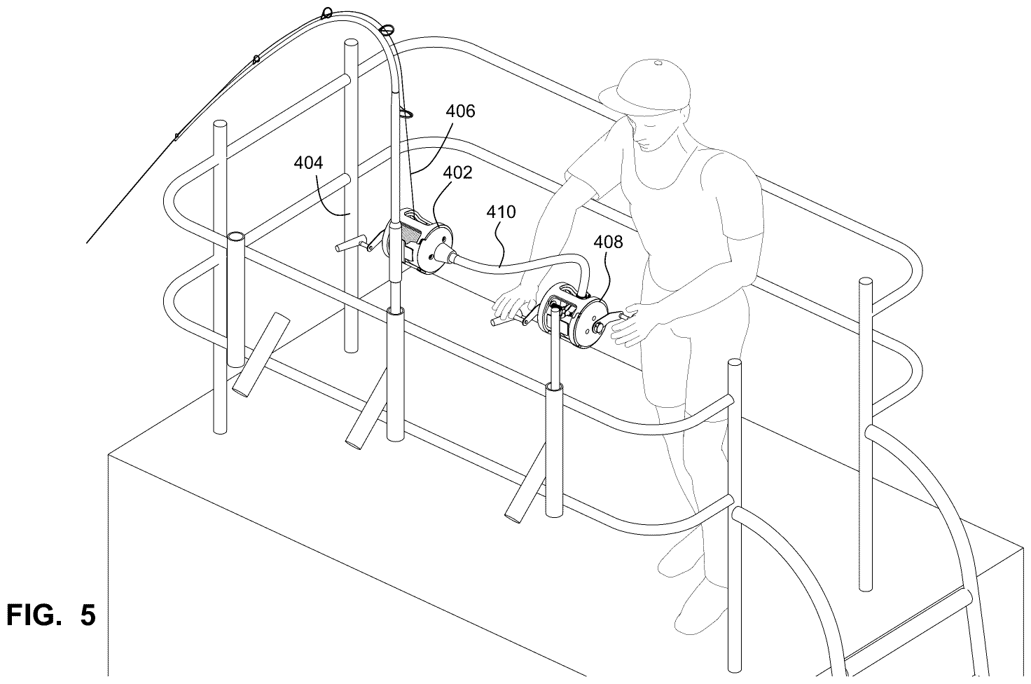

FIG. 5 shows yet another embodiment where a hand operated control mechanism 408 is coupled by a flex shaft 410 to a reel 402. In this embodiment, both reel 402 and reel 408 each have at least one handle, and these handles can operate independently or together to reel in a fish. Two different people can be operating these two different handle sets, and can thus work together to reel in a fish. Neither reeling effort will interfere with the other reeling effort. However, if the reel 402 is rotated backward, that rotation will not be transmitted to the device 408. This protects the internals and prevents hand or foot injuries.

The flex shaft arrangement is the same as shown in FIG. 2 except that the flex shaft 410 in the FIG. 5 example is much shorter than the one shown in FIG. 2. Flex shaft 410 can have any desired length such as 1 foot or 2 feet or 3 feet or 4 feet or 5 feet or 6 feet or 7 feet or 8 feet or 9 feet or 10 feet or 11 feet or 12 feet or 13 feet or 14 feet or so on. The flex shaft 410 is configured to transmit torque along straight or arbitrarily curved paths. See for example U.S. Pat. Nos. 4,362,520 & 6,189,900, each incorporated herein by reference. Certain embodiments can use straight shafts rather than flex shafts depending on alignment between the drive mechanism and the reel, but flex shafts offer advantages in terms of removability/replaceability, waterproof/weatherproof, salt water corrosion resistance, etc.

### Hand Operated Flex Shaft Drive

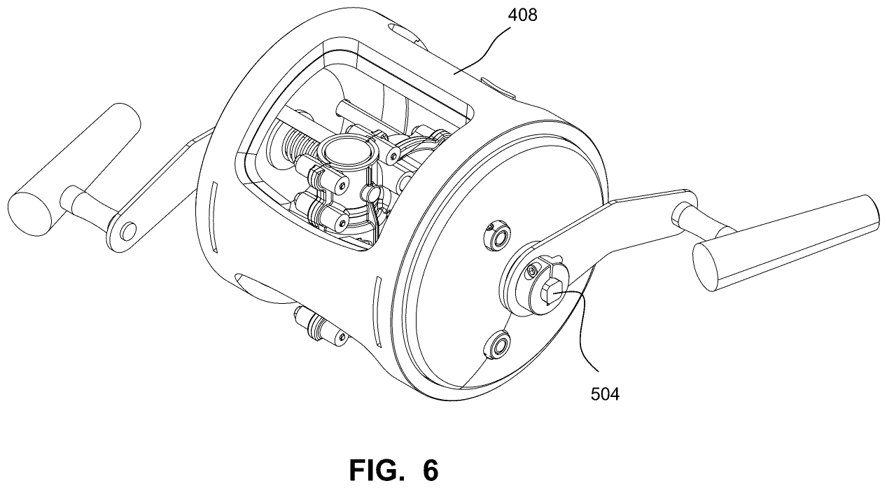

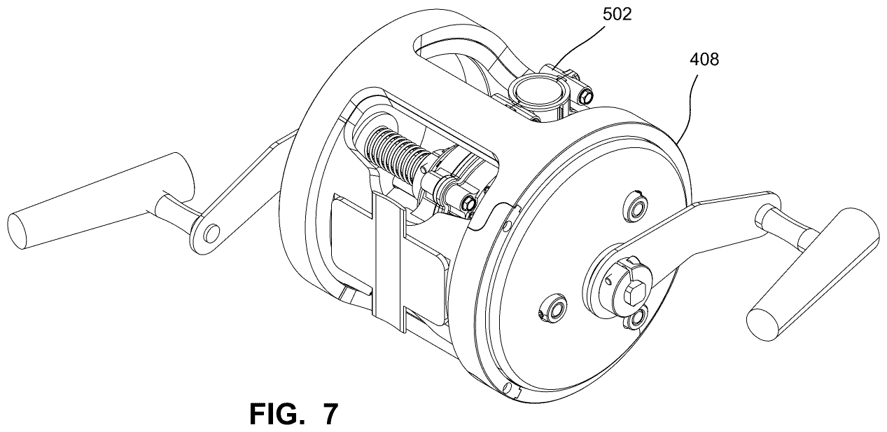

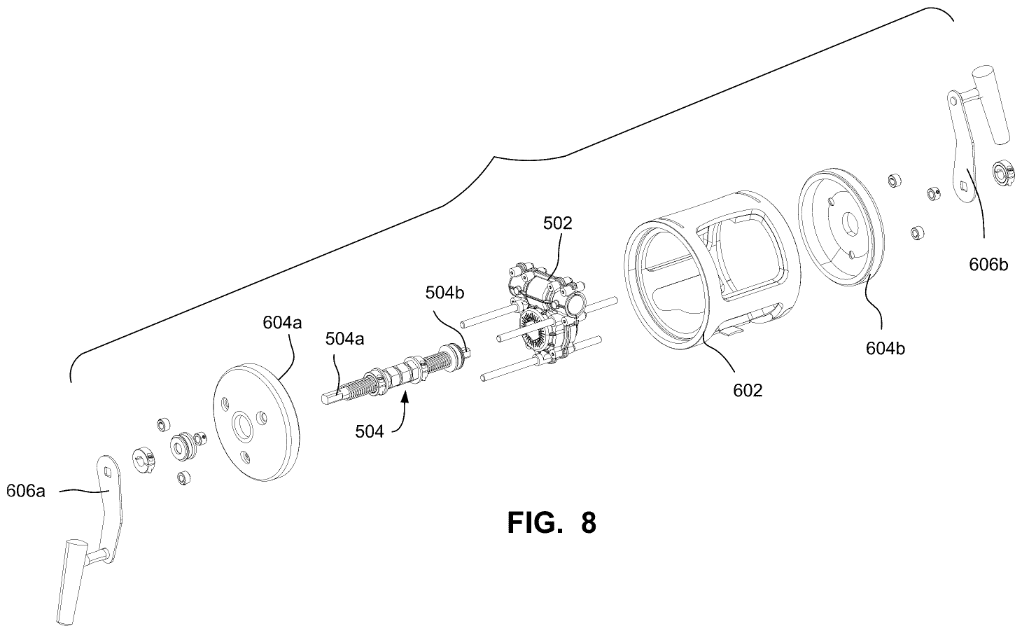

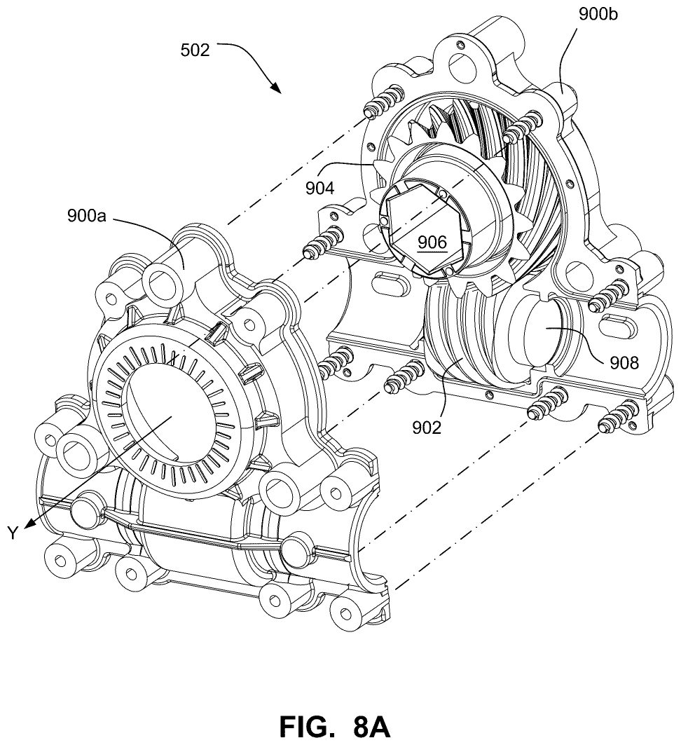

FIGS. 6 and 7 are perspective views of a hand operated drive mechanism 408, and FIGS. 8-10 show example exploded views. In the example shown, hand operated flex shaft drive mechanism 408 is in a form factor of an offshore fishing reel that has been modified to replace the spool with a gear box 502 having a flex shaft coupler port. However, other embodiments can have different form factors (see e.g., foot operated drive mechanism 408′ of FIG. 4, 4A). Note the springs inside which reduce effects of vibration to keep the handles on the rotatable central shaft.

The gear box 502 (which is fastened within the housing using three rods or bolts) is configured to receive torque (rotational energy) from a hand- (or foot, i.e., pedal operated) rotatable shaft 504 and convert it to uni-directional torque (rotational energy) about a different axis (e.g., 90 degrees from the hand-rotatable shaft 504) for coupling to a flexible shaft (“flex shaft”) 410. The gear box 502 includes an insertion port into which an end of the flex shaft 410 can be removably inserted and de-inserted.

FIG. 8A shows an exploded view of gear box 502. Gear box 502 includes a two-part casing 900 that encases a worm drive gear assembly including a rotatable worm (long cylindrical gear rotatable about its longitudinal axis) 902 that meshes with a circular rotatable worm gear 904. The worm drive gear assembly translates input torque about axis y to output torque about axis z, provides a one way clutch mechanism, and reverses the direction of rotation between input and output so that clockwise rotation of hand or foot pedals results in counterclockwise rotation of the spool on the other end of the flex shaft (i.e., via torque that is transmitted from rotating pedals or handles through a first gear box, through a flex shaft, and through a second gear box to a reel spool). The inner or central portion 906 of worm gear 904 defines a pentagonal opening that accepts and mates with a pentagonally-sided input shaft connected to hand-operated handles and/or foot-operated pedals. Rotation of the pentagonally-sided shaft (e.g., under foot and/or hand power) causes worm gear 904 to rotate about its longitudinal y axis. Such rotation of the worm gear 904 causes mating worm 902 to rotate about its center or z axis, where the y axis and z axis are orthogonal to one another. An inner or central portion of the worm 902 defines a flex shaft drive port including inner mating surfaces that mate to a distal end of a conventional flex shaft. See for example U.S. Pat. No. 6,668,680 incorporated herein by reference.

The FIG. 8 exploded view shows hand operated drive mechanism 408 comprising a hollow housing 602 capped by a side cap 604a on a first side and a side cap 604b on a second side. A shaft 504 positioned in a central portion of housing 602 has a first distal end 504a that connects with a first handle lever 606a on one side of the housing 602, a second distal end 504b that connects with a second handle lever 606b on the other side of housing 602, and a central portion that is configured and dimensioned to fit within and rotate the gearbox 502 worm gear. This shaft may also include one-way clutch assemblies that restrict the shaft to rotate in only one direction. Rotating the shaft 504 in the appropriate direction causes the worm gear 904 to rotate, which transmits torque to worm 902 and a flex shaft mated thereto. Rotating the shaft 504 in the other direction causes nothing to happen due to the operation of the one-way clutch.

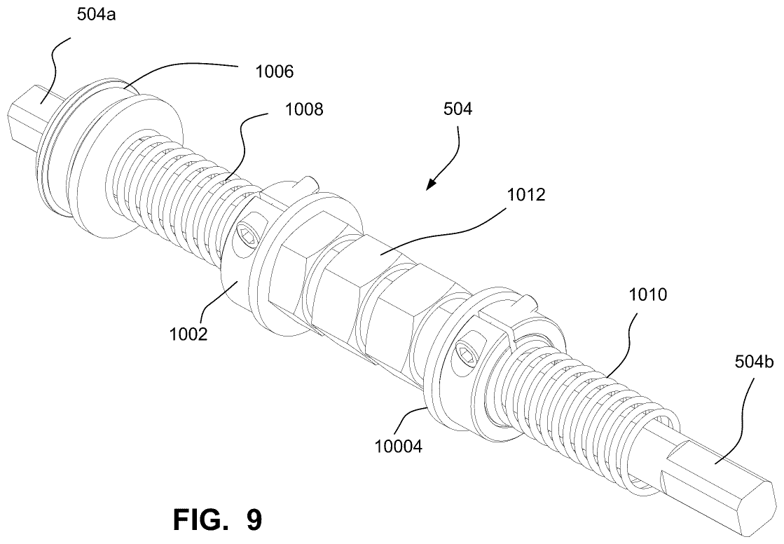

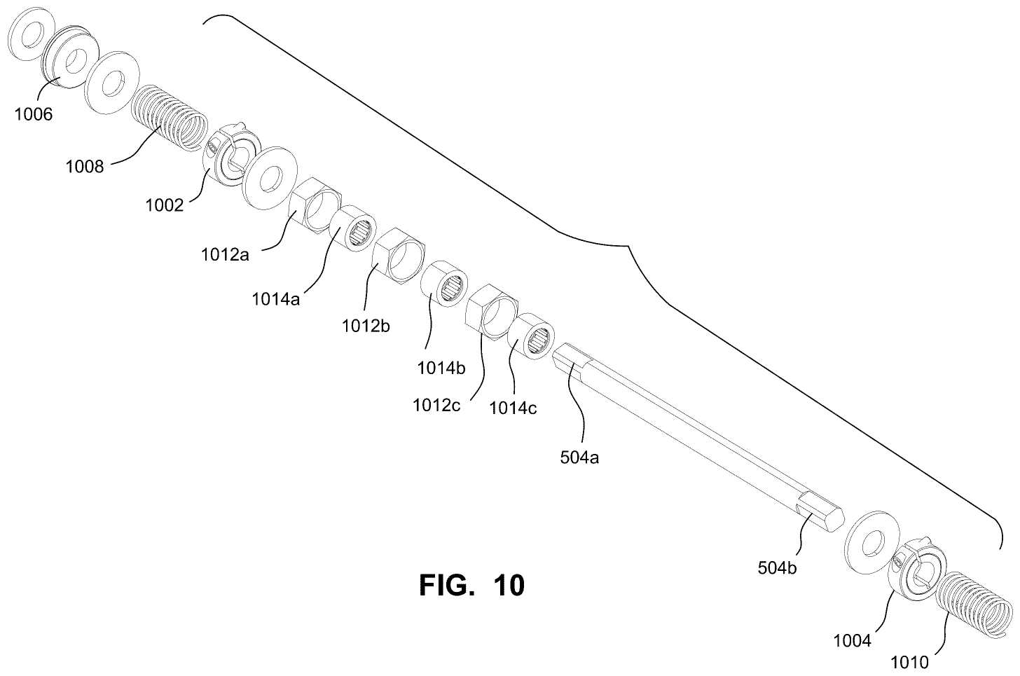

FIG. 9 shows a side perspective view of shaft 504, and FIG. 10 shows an exploded view of shaft 504 with various bearings, retaining nuts, washers, one way clutches, and other items disposed on the shaft. Items 1014a, 1014b, 1014c comprise one-way needle bearings providing one-way clutching that allow the shaft to spin in only one direction and restrict or prevent it from spinning in the opposite direction. These one-way needle bearings 1014 are each pressed into a corresponding hexagonal casing 1012a, 1012b, 1012c to fit the gearbox worm gear central shaft interior cavity. The hexagonal casings 1012 transmit torque between the rotating shaft and the gearbox worm gear, with the needle bearings restricting transmission of rotation to only one direction. Rotation of the handles or pedals in the opposite direction is possible, but the shaft freefloats in that direction of rotation and there is no transmission of torque in that direction. A collar 1006 maintains the axial direction of the shaft. The springs 1008, 1010 reduce vibration effects and ensure the shaft remains in longitudinal position. the nuts 1012 and internal roller bearings 1014 provide an engagement portion that engages the central cavity defined within the gearbox worm gear.

### Reel 402

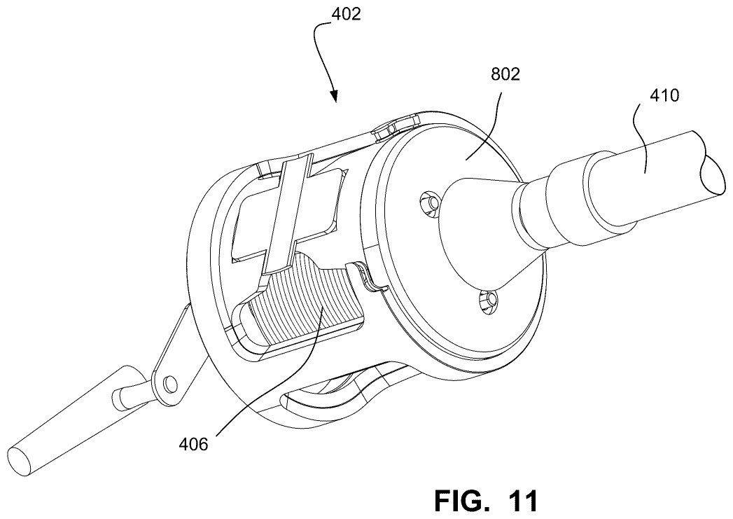

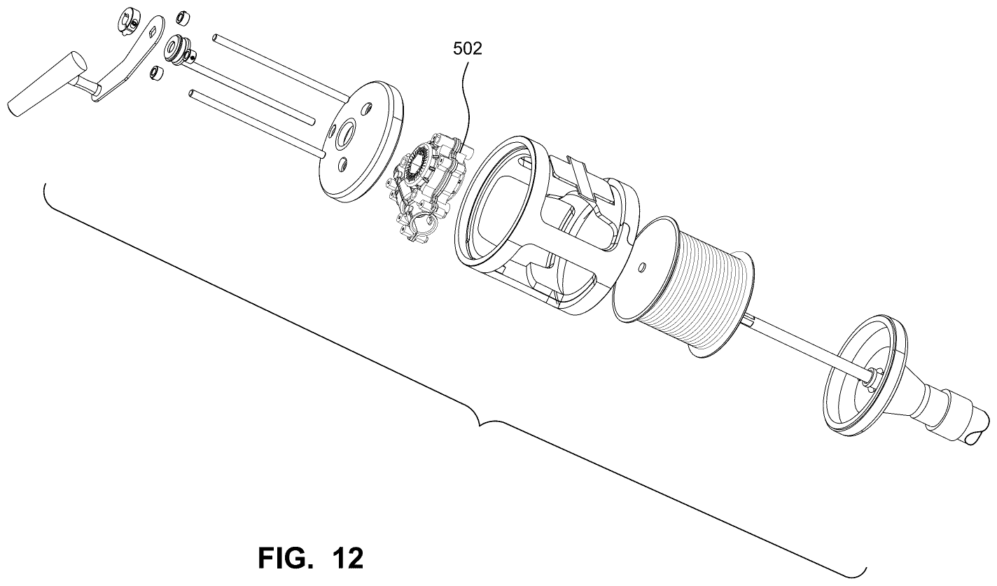

FIG. 11 shows a perspective view of reel 402. Reel 402 comprises a conventional deep sea fishing reel including spool carrying line, such as shown in FIG. 1. However, the FIG. 11 reel 402 has been modified to replace a side cap 802 and associated handle with a different side cap that mates with flex shaft 410. FIG. 12 shows an exploded view showing another gearbox 502 that is identical to the gearbox in the drive component described above, but in this case translates torque in the opposite direction, i.e., from the flex shaft to rotation of the spool.

All patents and publications cited above are hereby incorporated by reference.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A fishing apparatus comprising:
a reel comprising a spool;
a manual drive mechanism located remotely from the reel; and
a shaft that transmits torque from the manual drive mechanism to rotate the reel spool to retrieve line.

2. The fishing apparatus of claim 1 wherein the reel includes a first worm drive gearbox, the manual drive mechanism includes a second worm drive gearbox, and the flexible shaft transmits torque from the first worm drive gearbox to the second worm drive gearbox.

3. The fishing apparatus of claim 1 wherein the shaft comprises a flexible shaft.

4. The fishing apparatus of claim 1 wherein the manual drive mechanism includes a one-way clutch that restricts torque provided to the shaft to a single rotational direction corresponding to spool line retrieval.

5. The fishing apparatus of claim 1 wherein the manual drive mechanism includes at least one handle and/or at least one foot pedal.

6. The fishing apparatus of claim 1 wherein the reel is configured to be connected to a fishing pole.

7. The fishing apparatus of claim 1 wherein the reel is configured to be connected to a fighting chair.

8. The fishing apparatus of claim 1 wherein the reel has a single handle.

9. The fishing apparatus of claim 1 wherein the reel is housed in a first housing, and the manual drive mechanism is housed in a second housing different from the first housing.

10. The fishing apparatus of claim 1 wherein the shaft is removably coupled to the reel and to the manual drive mechanism.

11. The fishing apparatus of claim 1 wherein the manual drive mechanism is located remotely from the reel.

12. The fishing apparatus of claim 1 wherein the fishing apparatus is devoid of any electrical or electronic components, is purely mechanical in structure, and has no electric motors or other electrical drive components or mechanisms.
